(19) United States
(12) Patent Application Publication
(10) Pub. No.: US 2006/0206040 A1
(43) Pub. Date: Sep. 14, 2006

(54) APARATUS AND METHOD OF BODY CONTOURING AND SKIN CONDITIONING USING A MOBILE SUCTION DEVICE

(76) Inventor: RONALD ALLEN GREENBERG, SOUTH AUSTRALIA (AU)

Correspondence Address: IRVING M. WEINER;WEINER & BURT, P.C., 635 N. US-23, P.O. BOX 186, HARRISVILLE, MI, 48740, US

(21) Appl. No.: 11/164,547

(22) Filed: Nov. 29, 2005

(30) Foreign Application Priority Data
Mar. 9, 2005 (AU) 2005901110

(51) Int. Cl. A61H 7/00

(52) U.S. Cl. 601/9; 601/11; 601/7; 601/6

(57) ABSTRACT

The present invention provides an apparatus and method of body contouring and skin conditioning using a mobile handpiece 16. The mobile handpiece 16 treats cellulite and the like by producing vibrations in the subcutaneous layers of fat. A cup 18 of the mobile handpiece 16 is placed against the skin to create a chamber 60. A vacuum source 160 and compressor 162, which are in communication with chamber 60, are then controlled to produce an oscillating pressure within the chamber 60. This vibration of the skin surface is transferred through the dermal layers thereby influencing fluid retention and cellulite build up.

### BACKGROUND OF THE INVENTION

Cellulite is a skin condition often described as an ‘orange peel’, ‘mattress’, or ‘dimpling’ that appears primarily on the thighs, buttocks and sometimes lower abdomen of otherwise healthy people. Research has suggested that 95 percent of women will experience some level of cellulite at some time in their life. The condition may also affect men, however, this is not as common. Cellulite includes fat and fluids that have been trapped in connective tissue pockets beneath the skin.

The outermost layer of skin is referred to as epidermis. Below the epidermis is the dermis, which contains hair follicles, sweat glands, blood vessels, nerve receptors and connective tissue. Underneath the dermis is the first of three layers of subcutaneous fat. The uppermost layer of subcutaneous fat has been described as “standing fat-cell chambers” separated by connective tissue. Small projections of fat cells protrude from the fat-cell chambers into the dermis. This unevenness and irregularity of the subcutaneous fat gives skin the bumpy appearance which is commonly referred to as cellulite.

Water retention and fat build up in the adipose tissue results in an irregular or swollen appearance of a person's skin. The adipose tissue provides insulation and is divided into lobes by small blood vessels. The cells of this layer are adipocytes which are specialized in storing energy as fat.

It is believed that a good eating plan, increased activity, good posture and low stress levels can reduce water retention and fat build up. However, these aspects have limited effectiveness in treating cellulite. Various treatments have also been developed to treat cellulite or adipose tissue including creams, laser technologies, liposuction, and mesotherapy. Mesotherapy involves the use of hair thin needles to inject micro mixtures of vitamins, amino acids, supplements and pharmaceuticals into the middle layer of skin, in an attempt to break down fat cells and increase blood flow. Although the needles used in mesotherapy are thin, many people avoid this treatment because they are afraid of needles or the risk of disease, such as AIDS. Cream treatments are seen to be of limited usefulness and treatments like liposuction and mesotherapy are either expensive or may produce only temporary improvement. Many doctors even warn that liposuction is not an effective treatment for cellulite because liposuction is designed to remove deep fat instead of cellulite or adipose tissue, which is close to the skin surface.

A recently developed non-invasive cellulite reduction technique has been given the name Endermologie. Endermologie works by utilizing a device that sucks onto the skin while two rollers aggressively massage the underlying tissue. It has been suggested that about one third of patients will be able to benefit from this deep massage technique. Endermologie does however have its limitations. The strength of the massage is not suitable for some people and temporary bruising often occurs. Furthermore, the method is not suitable for women who are pregnant, have sensitive skin, or those with high blood pressure. One of the other problems with Endermologie is that the operator needs to be skilled so that they do not overly apply pressure thereby bruising the skin. The pressure needed to be applied by the operator may also result in a repetitive stain injury.

It is an object of the present invention to provide for an apparatus and method of body contouring and skin conditioning using a mobile handpiece that overcomes at least some of the aforementioned problems or provides the public with a useful alternative.

It is a further object of the present invention to provide for an apparatus and method of body contouring and skin conditioning using a mobile handpiece that produces vibrations in the layers of subcutaneous fat.

### SUMMARY OF THE INVENTION

Therefore in one form of the invention there is proposed an apparatus for body contouring and skin conditioning using a mobile handpiece, including:

a device for producing a pressure differential; and

a cup having at least a first and second opening, wherein said first opening is defined by a perimeter which when placed against a skin surface defines a chamber, and said second opening is in communication therethrough with said device for producing a pressure differential, whereby an oscillating pressure is produced within said chamber which causes said skin to vibrate.

In a further form of the invention there is proposed an apparatus for body contouring and skin conditioning using a mobile handpiece, including:

a source of compressed gas adapted to produce a stream of compressed gas;

a vacuum source adapted to produce a vacuum;

a cup having at least a first and second opening, wherein said first opening is defined by a perimeter which when placed against a skin surface defines a chamber, and said second opening is in selective communication therethrough with said source of compressed gas or vacuum source;

at least one valve adapted to selectively control the communication of said source of compressed gas and vacuum source with said cup, wherein an oscillating pressure is produced within said chamber thereby causes said skin to vibrate.

Preferably, said cup is adapted to slidably engage said handpiece.

Preferably, said handpiece includes at least one O-ring, wherein when said cup engages the handpiece the O-rings frictionally engages an inner surface of said cup thereby fixable engaging said cup.

Preferably, said apparatus includes a plurality of handpieces having different sized cups.

Preferably, said different handpieces can be selectively operated.

Preferably, said source of compressed gas is an air compressor.

Preferably, said source of compressed gas is a cylinder of compressed gas.

Preferably, the pressure within said chamber can be adjusted.

Preferably, said apparatus includes a foot pedal adapted to operate said source of compressed gas and vacuum source.

Preferably, said apparatus includes a handle adapted to be grasped by an operator and used to move said cup over the surface of said skin.

Preferably, said handpiece is connected to said source of compressed gas and vacuum source by way of a flexible hose.

Preferably, said apparatus includes a release valve for increasing the pressure within said chamber.

Preferably, said apparatus includes at least one control valve adapted to alter the pressure within said chamber.

Preferably, said perimeter of said cup includes a mobility device adapted to assist in the movement of said cup over said skin.

Preferably, said apparatus includes a device for applying a therapeutic substance to said skin.

Preferably, said cup includes a lubricating means to assist in the movement of said cup over said skin.

Preferably, said apparatus includes a temperature regulator for affecting the temperature of said skin during operation of said apparatus.

In yet a further form of the invention there is proposed a method of body contouring and skin conditioning using a mobile handpiece, including the step of:

placing said mobile handpiece onto a skin surface, whereby an opening of said mobile handpiece contacts said skin surface thereby defining a chamber;

operating a source of compressed gas and vacuum source to create an oscillating pressure within said chamber thereby causing tissue layers to vibrate; and

moving said mobile handpiece over said skin surface.

Preferably, said mobile handpiece can be moved in any direction during use.

Preferably, said vibrations are strong enough to affect the subdermal tissue.

Preferably, the pressure created by said source of compressed gas and vacuum source can be adjusted.

Preferably, said frequency of the pressure oscillations can be adjusted.

### BRIEF DESCRIPTION OF THE DRAWINGS

The accompanying drawings, which are incorporated in and constitute a part of this specification and, together with the description, serve to explain the advantages and principles of the invention. In the drawings,

FIG. 1 is a perspective view illustrating a first embodiment of an apparatus having a mobile handpiece;

FIG. 2 is a side cut away view of the mobile handpiece of FIG. 1;

FIG. 3 is an underside perspective view of the mobile handpiece of FIG. 1;

FIG. 4 is a perspective view of a second embodiment of the mobile handpiece;

FIG. 5 is a side cut away of a third embodiment of the mobile handpiece;

FIG. 6 is a side cut away view of mobile handpiece of FIG. 1 illustrating how the apparatus produces vibrations in the subcutaneous fat layer;

FIG. 7 is a perspective view of a fourth embodiment of an apparatus having a the mobile handpiece;

FIG. 8 is a front view of the control panel of FIG. 7;

FIG. 9 is a perspective view of a handpiece of FIG. 7 illustrating a large cup;

FIG. 10 is a perspective view of a handpiece of FIG. 7 illustrating a small cup;

FIG. 11 is a schematic view of the compressor and suction device of the apparatus of FIG. 7;

FIG. 12 is a schematic view illustrating an alternate arrangement of the compressor and suction device of the apparatus of FIG. 7;

FIG. 13 is a rear view of the apparatus of FIG. 7; and

FIG. 14 is a perspective view of the apparatus of FIG. 7 illustrating the use of additional devices.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

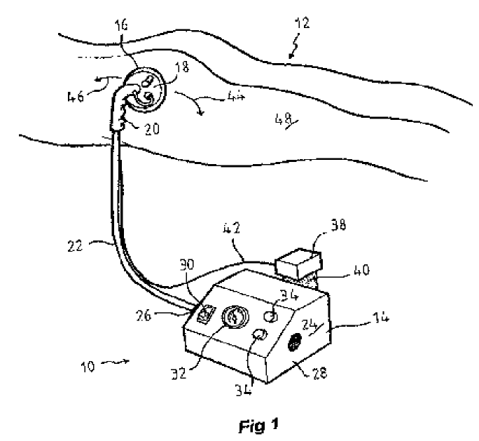

Illustrated in FIG. 1 is an apparatus 10 for the body contouring and skin conditioning of a person 12. The apparatus 10 includes a vacuum/compressor source 14 and a mobile handpiece 16 having a cup 18 adapted to engage the surface of a person's body 12 and a handle 20 to help a user grasp the mobile handpiece 16 during operation. The mobile handpiece 16 is connected to the vacuum/compressor source 14 via tube 22. The vacuum/compressor source 14 includes a housing 24, a hollow mount 26 connected to tube 22, an atmospheric air communication device 28, a switch 30 adapted to operate vacuum/compressor source 14, a gauge 32 adapted to measure pressure within cup 18 and control valves 34 adapted to alter the strength of the vacuum and compression produced by the vacuum/compressor source 14 during operation. The reader should appreciate that the vacuum/compressor source 14 may be connected to mains power or may have an enclosed battery to provide greater portability. Although we refer to a vacuum/compressor source 14 any means may indeed be used whereby there is a pressure differential.

The apparatus 10 further includes a supply container 38 that contains a therapeutic substance or substances 40. The supply container 38 is connected to the mobile handpiece 16 via tube 42. In this way the therapeutic substances 40 are drawn out of the supply container 38 by the vacuum produced by the vacuum/compressor source 14. It should however be appreciated by the reader that the apparatus 10 may include a motorised dispelling means (not shown) that disseminates the therapeutic substances 38 within the suction devices 16.

During operation it is envisaged that the mobile handpiece 16 can be moved in a multiplicity of directions, for instance as illustrated in FIG. 1, in the directions of arrows 44 or 46. This provides significant advantages since the mobile handpiece 16 does not need to be removed from the patient's body and can remain in close proximity to the patient's skin 48 at all times during operation of the apparatus 10.

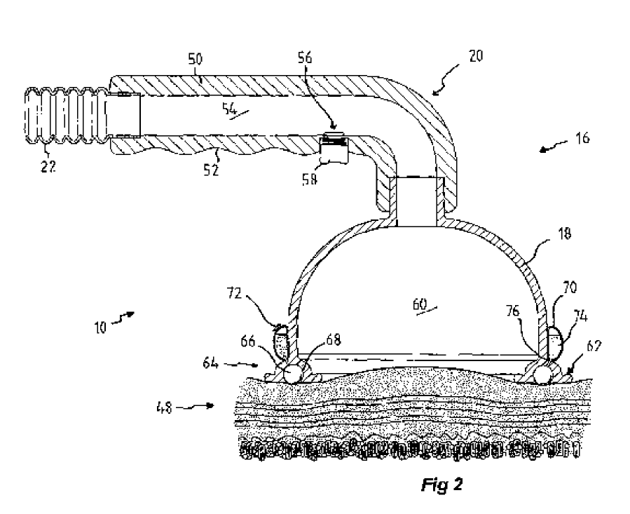

As illustrated in FIG. 2, the handle 20 of the mobile handpiece 16 can be in the form of a pistol type grip that includes a body 50 having finger grooves 52 and a duct 54 adapted to provide communication between the cup 18 and tube 22. The handle 20 further includes a release valve 56 operated by a trigger 58. The release valve 56 is configured to equalise the pressure within the chamber 60, defined by the cup 18 and the surface of the patient's skin 48, with the atmospheric pressure. This release ensures that the cup 18 can be easily removed from the skin 48. The release valve 56 may also be used in conjunction with control valves 34 to adjust the pressure within chamber 60.

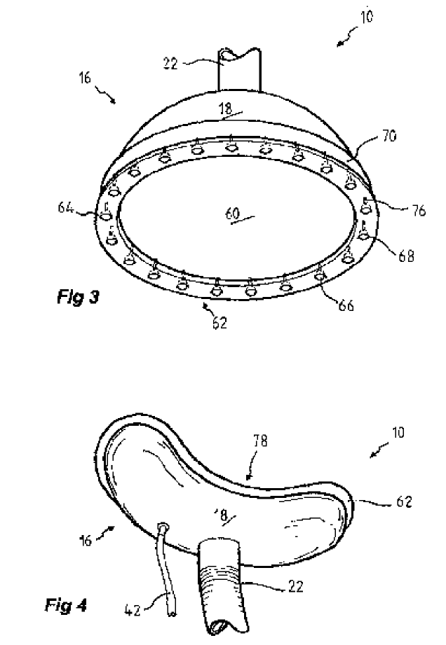

The perimeter 62 of the cup 18 includes a mobility device 64 adapted to assist in the movement of the mobile handpiece 16 over the surface of the skin 48. As illustrated in FIG. 2, the mobility device 64 is in the form of a series of ball bearings 66 accommodated within a cavity 68. The apparatus 10 further includes a refillable lubricant dispenser 70 that extends around the circumference of the cup 18 in close proximity to the perimeter 62. The lubricant dispenser 70 may be refilled by way of a removable cap 72. The lubricant 74 may be a therapeutic substance 40 however the invention is not limited to the use of therapeutic substances 40. As illustrated in FIG. 3, the lubricant dispenser 70 is adapted to release a lubricant 74 through duct 76 to thereby lubricating the mobility device 64.

Although larger areas such as thighs and buttocks are prone to cellulite, other smaller areas such as the face and neck may also be affected by cellulite or water retention and fat build up in the adipose tissue. For this reason, several cups 18 of varied shape and size may be removably attached to tube 22 depending upon the target area of the person 12 being treated. For instance, as illustrated is FIG. 4, the cup 18 may be kidney shaped 78 to facilitate the treatment of cellulite or adipose tissue on the face of a person 12. The reader will now appreciate that several different shaped cups 18 may be removably connected to the vacuum/compressor source 14 via tube 22 to facilitate the treatment of various areas of a person's body 12. The reader should appreciate that the diameter of the tube 22 may be varied or the communication between the tube 22 and cup 18 may be restricted to provided different pressure strengths. Furthermore, there may be various sizes of cups 18 so that the treatment can be tailored to the specific physiological attributes of the person 12.

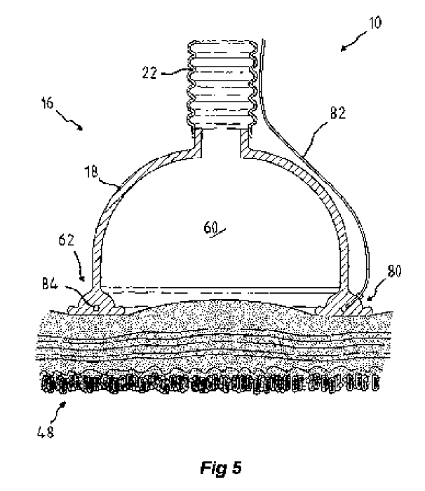

As illustrated in FIG. 5, the mobile handpiece 16 includes a temperature regulator 80 adapted to affect the temperature of the skin 48. The temperature regulator 80 is connected to a power source (not shown) via cable 82. The temperature regulator 80 may be in the form of a heating element 84 that extends around the perimeter 62 of the cup 18 in close proximity to the surface of the skin 48. The element 84 heats the cup 18 which in turn heats the air contained within the chamber 60. However, the reader should appreciate that the invention is not limited to a heating element 84. The temperature regulator 80 may alternatively be configured to lower the temperature of the skin 48. For instance, cold air could be injected at regular intervals into the chamber 60 in close proximity to the surface of the skin 48.

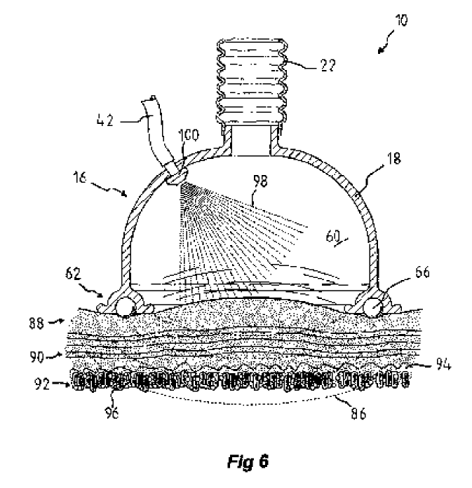

During use of the apparatus 10 the pressure within the chamber 60 is varied by the vacuum/compressor source 14. This pulsing of the pressure within the chamber 60 creates vibrations 86, as illustrated by the semicircular perforated lines in FIG. 6. These vibrations 86 pass through upper layers of skin referred to as the epidermis 88 and dermis 90 layers. The vibrations 86 then pass into the subcutaneous fat layer 92. The subcutaneous fat layer 92 contains small projections of fat cells 94 that protrude into the dermis 90 giving the appearance of what is referred to as cellulite. These clusters of fat cells 94 also result in fluid retention which can further worsen the appearance of the cellulite. By causing vibration of the subcutaneous fat layer 92 the apparatus 10 is able to help break apart the clusters of fat cells 94 and release the water 96. This assists the lymphatic system in draining the excessive fat cells 94 and water 96 from the subcutaneous fat layer 92, thereby reducing the visible effects of a build up of cellulite.

It should be appreciated that the pressure within the chamber 60 is increased to a point that allows the cup to be moved easily across the skin 48. The reader will now appreciate that because of the pulsing of the pressure within the chamber 60 the cup 18 can be moved across the skin 48 in a stop start fashion. Wherein, when the pressure within the chamber 60 is decreased to a certain point the cup 18 fastens onto the skin 48 and when the pressure within the chamber 60 is increased to a certain point the cup 18 is free to be moved across the skin 48 by the operator. As further illustrated in FIG. 6, the therapeutic substance or substances 40 may be disseminated into chamber 60 in a fine mist 98 through outlet 100 during operation of the apparatus 10. Alternatively, oil or cream could be applied directly to the person's body 12 before treatment with apparatus 10.

The vibration or more accurately resonate frequencies of all matter, whether inorganic and organic, are specific and unique. Each tissue in the human body has individualized frequencies. The resonate frequency of organs such as the heart is around 6 Hz while the resonate frequency of skin is around 1 Hz. Fat cells have a different resonate frequency to muscles cells. Therefore, the frequency of vibration may be chosen to be close to the natural frequency of the fat cells thereby amplifying the affect of the apparatus 10. It should be appreciated by the reader that the frequency may be adjusted by use of the control valves 34 adapted to alter the strength and frequency of the vacuum and compression produced by the vacuum/compressor source 14 during operation. It is envisaged that the frequency of vibration within chamber 60 ranges from 10-200 Hz with high frequency vibrations in the range of 1-20 kHz, however, the reader should appreciate that the present invention is not limited to these pressures or frequencies.

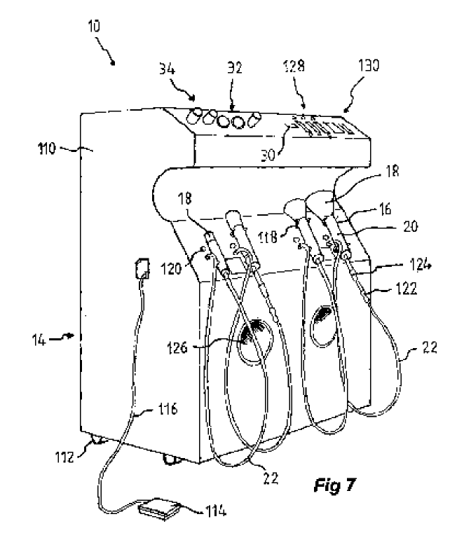

In a preferred embodiment as illustrated in FIG. 7, the apparatus 10 include a console 110 adapted to house the vacuum/compressor source 14. The console 110 is mounted on legs or roller 112 to assist in the transportation of the apparatus 10. The apparatus further includes a foot peddle 114, connected to the vacuum/compressor source 14 by way of cable 116, which is adapted to control the operation of the apparatus 10, thereby facilitating ease of use. As illustrated in FIG. 7 the apparatus includes a plurality of mobile handpieces 16 with different sized cups 18. This ensures that the user does not have to replace the cup 18 every time a different size is required. The plurality of mobile suction devices 16 are adapted to engage clips 118 on the front of the console 110. A light 120 corresponding to each mobile handpiece 16 indicates which device is in use.

The tube 22 connected to the vacuum/compressor source 14 includes a venturi tube 122 adapted to regulate the passage of air therethrough and filter 124 to ensure that foreign material such as dirt does not enter the vacuum/compressor source 14 which could cause mechanical failure. The console 110 includes vents 126 to provide ventilation for the vacuum/compressor source 14. An instrument panel 128 is provided at the top of the console 110 and includes on/off switch 30, gauges 32, control valves 34 and auxiliary switches 130.

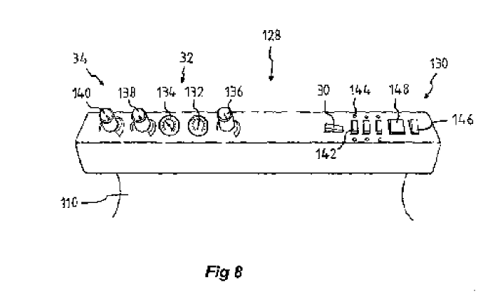

As illustrated in FIG. 8 the control panel 128 includes gauges 132 and 134. Gauge 132 is adapted to measure the compressed air flow produced by source 14, corresponding switch 136 is configured to adjust the compressed air flow. Gauge 134 is configured to measure the vacuum produced by source 14. Corresponding switch 138 is adapted to adjust the production of the vacuum by source 14, while switch 140 is for fine adjustment. The control panel 128 further includes auxiliary switches 130 for controlling the operation of the apparatus 10. The auxiliary switches 130 include selector switches 142, with indicator lights 144, used for selection an individual mobile handpieces 16, switch 146 and display panel 148. The reader should however appreciate that the present invention is not limited to this configuration of switches and gauges.

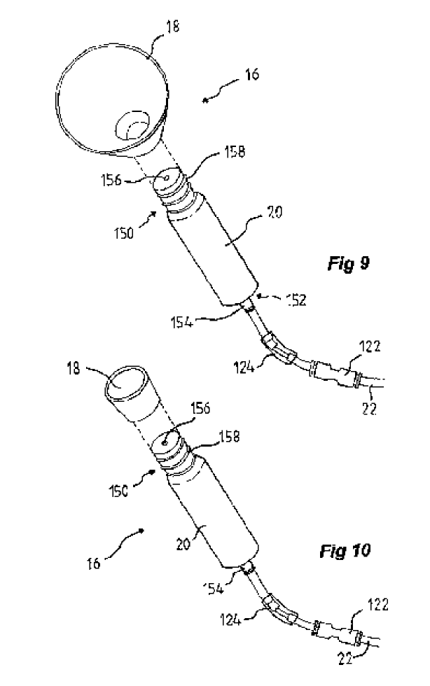

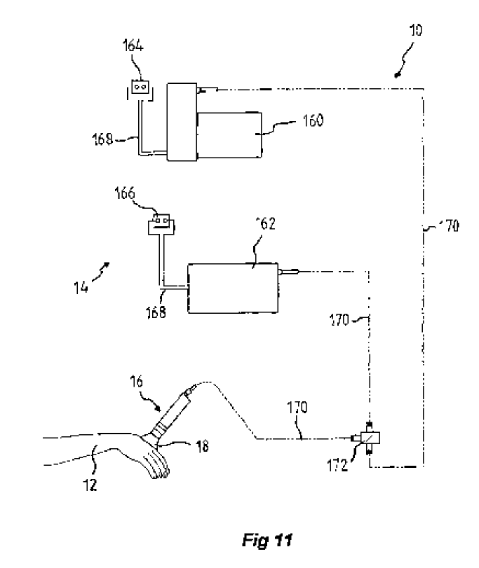

FIGS. 9 and 10 illustrate the handle 20 of the mobile handpiece 16 engaging different sized cups 18. The handle 20 includes a first end 150 adapted to engage a cup 18 and a second end 152 which includes a boss 154 adapted to connect to tube 22. The first end 150 includes an aperture 156 in communication with tube 22 and a series of O-rings 158. The cup 18 slidably engages the first end 150 and is held in place by the frictional force of the O-rings 158 as is well known in the art.

As illustrated in FIG. 11, the vacuum/compressor source 14 includes a vacuum producing device 160 and a compressor 162. The vacuum producing device 160 and compressor 162 are connected to respective power sources 164 and 166 by way of electrical cables 168. The vacuum producing device 160 and compressor 162 are in communication 170 with selector switch 172. The selector switch 172 determines which of the devices 160 or 162 is in communication 170 with the mobile handpiece 16. This produces a cyclic oscillation of the pressure within cup 18, from a higher than atmospheric pressure to a lower than atmospheric pressure.

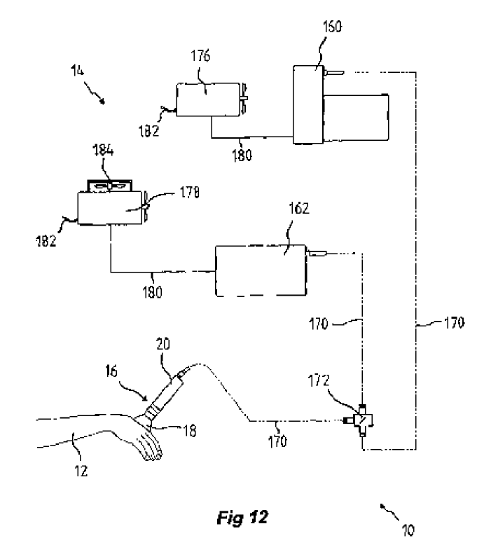

As illustrated in FIG. 12, vacuum producing device 160 and compressor 162 are connected to respective electric motors 176 and 178 by way of cables 180. Motors 176 and 178 are connected to a power source by way of electrical cable 182. The motor 178 corresponding to compressor 162 includes an additional fan 184 to assist in cooling.

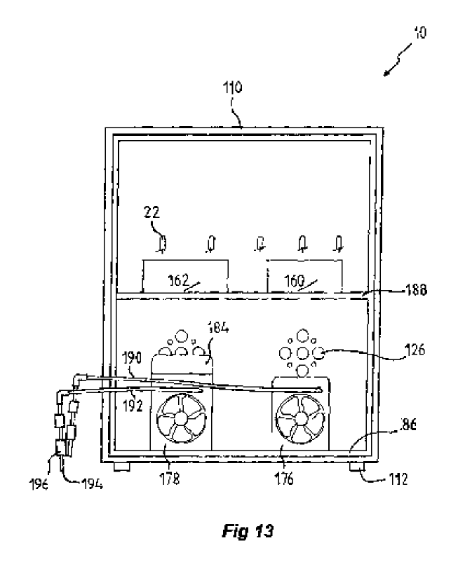

FIG. 13 illustrates the rear of the console 110 with the back panel removed. The motor 176 and 178 are mounted on the base 186 of the console 110 adjacent to vents 126. The vacuum producing device 160 and compressor 162 are mounted on shelf 188. Inlet tubes 190 and 192 are configured to supply air to vacuum producing device 160 and a compressor 162 respectively, which are in fluid communication with mobile handpiece 16 through pipes 22. The supply tubes 190 and 192 include an opening 194 and filters 196.

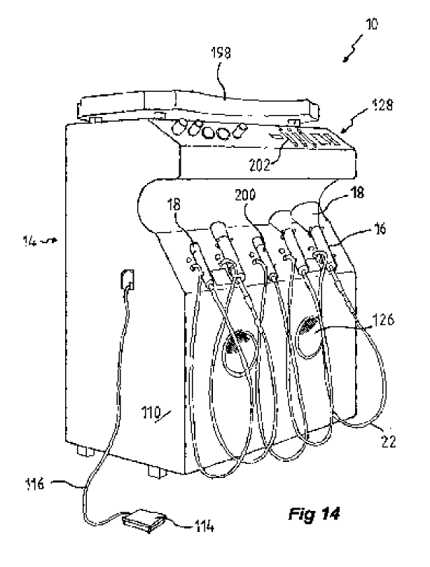

As illustrated in FIG. 14, the apparatus 10 can be used in conjunction with additional treatment devices, including electrical signal applicator 198 and oxygen infusing handpiece 200 which is controlled by switch 202.

It should be appreciated by the reader that the present description provides, by way of example, one arrangement in which the principles of the present invention may be employed. It should however be appreciated that the present invention is not limited to this particular embodiment. It has been described that an air compressor and vacuum source alternately communicate with the cup, however, it should be appreciated that any device could be used to produce a pressure differential. It has also been discussed that the pressure within the cup alternates between two states; one of greater than atmospheric pressure and the other of lower than atmospheric pressure. It should however be appreciated that the pressure within the cup does not need to be lower than atmospheric pressure. The pressure states within the cup could alternate both be greater than atmospheric pressure.

The skilled addressee will now appreciate the many advantages of the present invention for an apparatus and method of body contouring and skin conditioning using a mobile handpiece. The invention provides a non-invasive method for treating cellulite that overcomes many of the limitation of currently available treatments. The apparatus 10 provides a treatment that reduces the visible effects of cellulite by assisting the drainage of the lymphatic system with minimal discomfort to the patient. As the reader will now appreciate the use of pulsating pressure within the chamber 60 creates vibrations that pass into the subdermal tissue. This avoids the use of an aggressive massage of the underlying tissue which can result in such problems as bruising and which is not suitable for some people including those who are pregnant. The present method also means that there is less impact on the operator thereby reducing the risk of repetitive strain injuries. As the reader will now appreciate the present invention provides an exemplary way of treating cellulite and adipose tissue that is both gentle on the patient and operator.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In the summary of the invention, except where the context requires otherwise due to express language or necessary implication, the word “comprising” is used in the sense of “including”, i.e. the features specified may be associated with further features in various embodiments of the invention.

What is claimed is:

1. An apparatus for body contouring and skin conditioning using a mobile handpiece, including:
a device for producing a pressure differential; and
a cup having at least a first and second opening, wherein said first opening is defined by a perimeter which when placed against a skin surface defines a chamber, and said second opening is in communication therethrough with said device for producing a pressure differential, whereby an oscillating pressure is produced within said chamber which causes said skin to vibrate.

2. An apparatus for body contouring and skin conditioning using a mobile handpiece, including:
a source of compressed gas adapted to produce a stream of compressed air;
a vacuum source adapted to produce a vacuum;
a cup having at least a first and second opening, wherein said first opening is defined by a perimeter which when placed against a skin surface defines a chamber, and said second opening is in selective communication therethrough with said source of compressed gas or vacuum source;
at least one valve adapted to selectively control the communication of said source of compressed gas and vacuum source with said cup, wherein an oscillating pressure is produced within said chamber thereby causes said skin to vibrate.

3. An apparatus as in claim 2, wherein said cup is adapted to slidably engage said handpiece.

4. An apparatus as in claim 3, wherein said handpiece includes at least one O-ring, whereby when said cup engages the handpiece the O-rings frictionally engages an inner surface of said cup thereby fixably engaging said cup.

5. An apparatus as in claim 2, wherein said apparatus includes a plurality of handpieces having different sized cups.

6. An apparatus as in claim 5, wherein said different handpieces can be selectively operated.

7. An apparatus as in claim 2, wherein said source of compressed gas is an air compressor.

8. An apparatus as in claim 2, wherein said source of compressed air is a cylinder of compressed gas.

9. An apparatus as in claim 2, wherein the pressure within said chamber can be adjusted.

10. An apparatus as in claim 2, wherein said apparatus includes a foot pedal adapted to operate said source of compressed gas and vacuum source.

11. An apparatus as in claim 2, wherein said apparatus includes a handle adapted to be grasped by an operator and used to move said cup over the surface of said skin.

12. An apparatus as in claim 2, wherein said handpiece is connected to said source of compressed gas and vacuum source by way of a flexible hose.

13. An apparatus as in claim 2, wherein said apparatus includes a release valve for increasing the pressure within said chamber.

14. An apparatus as in claim 2, wherein said apparatus includes at least one control valve adapted to alter the pressure within said chamber.

15. An apparatus as in claim 2, wherein said perimeter of said cup includes a mobility device adapted to assist in the movement of said cup over said skin.

16. An apparatus as in claim 2, wherein said apparatus includes a device for applying a therapeutic substance to said skin.

17. An apparatus as in claim 2, wherein said cup includes a lubricating means to assist in the movement of said cup over said skin.

18. An apparatus as in claim 2, wherein said apparatus includes a temperature regulator for affecting the temperature of said skin during operation of said apparatus.

19. A method of body contouring and skin conditioning using a mobile handpiece, including the step of:
placing said mobile handpiece onto a skin surface, whereby an opening of said mobile handpiece contacts said skin surface thereby defining a chamber;
operating a source of compressed gas and vacuum source to create an oscillating pressure within said chamber thereby causing tissue layers to vibrate; and moving said mobile handpiece over said skin surface.

20. A method as in claim 19, wherein said mobile handpiece can be moved in any direction during use.

21. A method as in claim 19, wherein said vibrations are strong enough to affect the subdermal tissue.

22. A method as in claim 19, wherein the pressure created by said source of compressed gas and vacuum source can be adjusted.

23. A method as in claim 19, wherein said frequency of the pressure oscillations can be adjusted.
